(19) United States
(12) Patent Application Publication
(10) Pub. No.: US 2017/0004847 A1
(43) Pub. Date: Jan. 5, 2017

(54) INFORMATION PROCESSING DEVICE AND IMAGE FORMING APPARATUS

(71) Applicant: KYOCERA Document Solutions Inc., Osaka (JP)

(72) Inventor: Ryo SHIOMI, Osaka-shi (JP)

(73) Assignee: KYOCERA Document Solutions Inc., Osaka (JP)

(21) Appl. No.: 15/195,273

(22) Filed: Jun. 28, 2016

(30) Foreign Application Priority Data
Jun. 30, 2015 (JP) 2015-131180

(51) Int. Cl. G10L 25/51; H04N 1/04; G10L 15/02

(52) U.S. Cl. CPC G10L 25/51; G10L 15/02; H04N 1/04; H04N 2201/0094

(57) ABSTRACT

An information processing device includes a voice recorder, a retrieval section, and an analysis section. The information processing device utilizes a meeting report on a meeting. The voice recorder records utterances during the meeting. The retrieval section retrieves an utterance of a term entered in the meeting report from among the utterances recorded on the voice recorder. The analysis section analyzes a content of the meeting based on the utterance of the term.

### INCORPORATION BY REFERENCE

The present application claims priority under U.S.C. §119 to Japanese Patent Application No. 2015-131180, filed on Jun. 30, 2015. The contents of this application are incorporated herein by reference in their entirety.

### BACKGROUND

The present disclosure relates to an information processing device and an image forming apparatus.

An electronic meeting system includes a client machine installed in a room in which a meeting is held. The client machine includes an acquisition section, a control section, and a storage section. The acquisition section acquires information on one or more events occurring during a meeting. The control section records the information on the events as an object into the storage section and acquires additional information on the events and records it along with the object. The control section produces a meeting report in a manner to display the object in time series based on the additional information.

### SUMMARY

An information processing device according to a first aspect of the present disclosure utilizes a meeting report on a meeting. The information processing device includes a voice recorder, a retrieval section, and an analysis section. The voice recorder records utterances during the meeting. The retrieval section retrieves an utterance of a term entered in the meeting report from among the utterances recorded on the voice recorder. The analysis section analyzes a content of the meeting based on the utterance of the term.

An image forming apparatus according to a second aspect of the present disclosure includes the information processing device according to the first aspect of the present disclosure and an image forming section. The image forming section forms an image indicating a result of analysis of the meeting on a sheet.

### BRIEF DESCRIPTION OF THE DRAWINGS

FIG. 1 illustrates a configuration of an information processing device according to a first embodiment of the present disclosure.

FIG. 2 indicates a meeting report that the information processing device according to the first embodiment of the present disclosure utilizes and terms extracted from the meeting report.

FIG. 3 indicates the respective numbers of utterances of a tem recorded on the meeting report that the information processing device according to the first embodiment of the present disclosure utilizes.

FIG. 4 is a flowchart depicting a control process for analysis of meeting contents executed by an analysis section of the information processing device in the first embodiment of the present disclosure.

FIG. 5 is a schematic cross sectional view explaining an image forming apparatus according to a second embodiment of the present disclosure.

### DETAILED DESCRIPTION

Following describes embodiments of the present disclosure with reference to the accompanying drawings. Note that elements that are the same or equivalent are indicated by the same reference signs in the drawings and explanation thereof is not repeated.

### First Embodiment

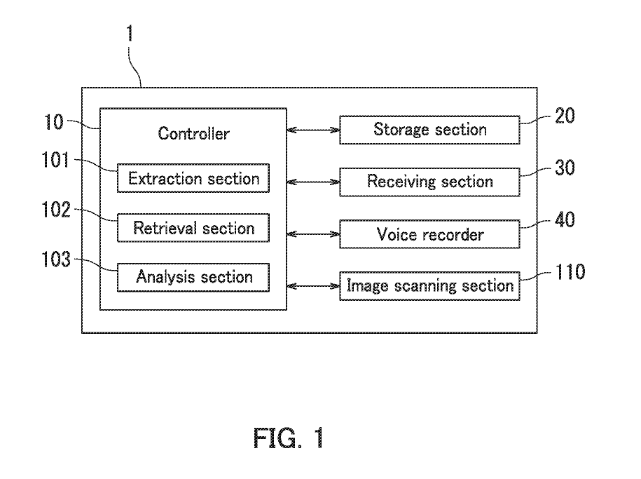

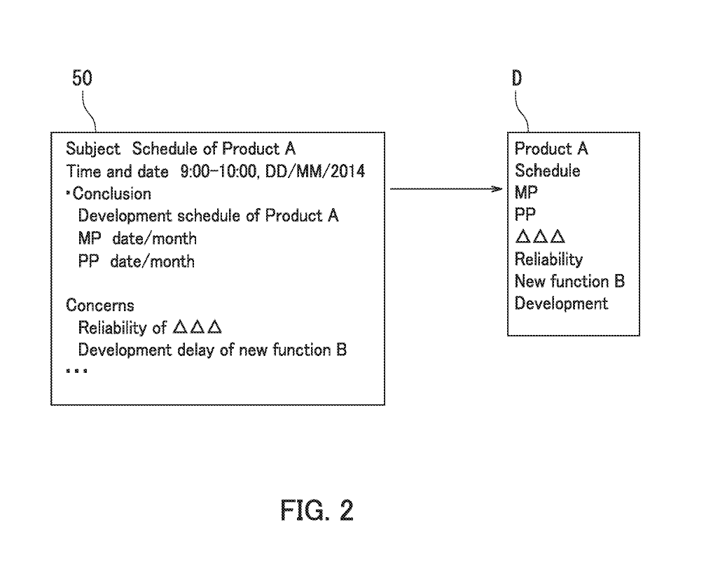

An information processing device 1 according to a first embodiment of the present disclosure will be described with reference to FIGS. 1-3. FIG. 1 illustrates a configuration of the information processing device 1. FIG. 2 indicates a meeting report 50 and terms D extracted from the meeting report 50. The information processing device 1 utilizes the meeting report 50 about a meeting. The meeting report 50 is produced by for example a participant of the meeting. Meeting contents are entered in the meeting report 50. The meeting contents include for example date and time at which the meeting was held, an item determined in the meeting, and a content of a participant's comment. That is, terms entered in the meeting report 50 are significant words in the meeting. In the present embodiment, the meeting report 50 is in the form of text data. The information processing device 1 includes a controller 10, a storage section 20, a receiving section 30, a voice recorder 40, and an image scanning section 110.

The storage section 20 includes a main storage device (for example, a semiconductor memory) such as a read only memory (ROM) or a random access memory (RAM), and an auxiliary storage device (for example, a hard disk drive). The main storage device stores therein a variety of computer programs that the controller 10 executes.

The voice recorder 40 records utterances during the meeting. For example, the voice recorder 40 converts the utterances during the meeting to data in a file format in accordance with a standard such as pulse code modulation (PCM) or PM3 (Moving Picture Experts Group (MPEG) Audio Layer 111) and records the data into the storage section 20. The information processing device 1 herein is installed in a room in which the meeting is held, for example. In a situation in which a room in which the information processing device 1 is installed is different from a room in which the meeting is held, the utterances during the meeting may be recorded into the storage section 20 through receipt of the utterance during the meeting via a network.

The controller 10 is a central processing unit (CPU), for example. The controller 10 includes an extraction section 101, a retrieval section 102, and an analysis section 103. The controller 10 functions as the extraction section 101, the retrieval section 102, and the analysis section 103 through execution of computer programs stored in the storage section 20.

The extraction section 101 extracts a term D entered in the meeting report 50. For example, the extraction section 101 first performs component analysis on the meeting report 50. The component analysis herein involves dividing a sentence into terms (components) in a minimum semantic unit and determining a part of speech of each of the divided terms by referencing predetermined database. The extraction section 101 subsequently extracts a term D determined as a specific part of speech. Note that a user can set any part of speech as the specific part of speech. The extraction section 101 extracts for example a “product A” as the term D from the meeting report 50, as illustrated in FIG. 2.

The retrieval section 102 retrieves an utterance of the term D entered in the meeting report 50 from among the utterances recorded on the voice recorder 40. Specifically, data to which each utterance in the meeting is converted is stored in the storage section 20. The retrieval section 102 accordingly retrieves data indicating an utterance determined to agree with the utterance of the term D from among the utterances in the meeting converted to the data. Furthermore, in a situation in which a plurality of participants participated in the meeting, the retrieval section 102 retrieves the utterance of the term D from among utterances by the respective participants present in the meeting that are recorded on the voice recorder 40.

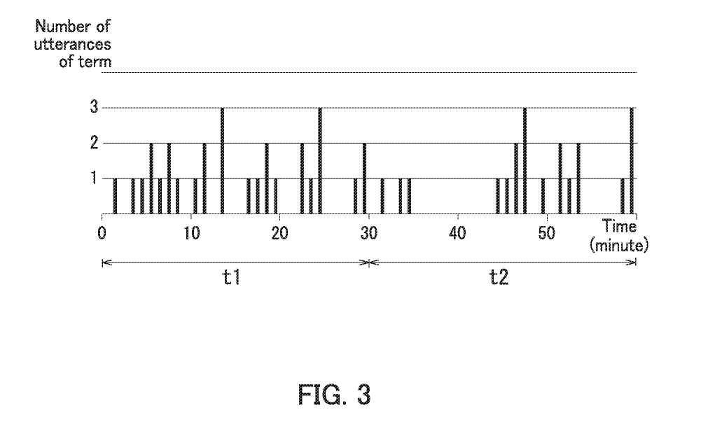

The analysis section 103 analyzes the meeting contents based on the utterance of the term D. FIG. 3 indicates the respective numbers of times of utterances of the term D during the meeting. The horizontal axis in FIG. 3 indicates elapsed time in the meeting. On the other hand, the vertical axis in FIG. 3 indicates the numbers of utterances of the term D as time proceeds. The meeting includes a first time zone t1 and a second time zone t2. In the present embodiment, the first time zone 1t ranges from time when the meeting starts to time when 30 minute elapses after the start, and the second time zone t2 ranges from time when 30 minutes elapses after the start to time when the meeting closes. Note that the time period of the first zone t1 may differ from that of the second time zone t2.

For example, the analysis section 103 analyzes the meeting contents based on either or both of the number and total time length of the utterances of the term D.

A description will be made first about a configuration in which the analysis section 103 analyzes the meeting contents based on the number of utterances of the term D. The analysis section 103 analyzes the meeting contents through comparison between the number of utterances of the term D in the first time zone t1 of the meeting and the number of utterances of the term D in the second time zone t2 of the meeting. For example, the term D is uttered 29 times in the first time zone t1, as illustrated in FIG. 3. On the other hand, the term D is uttered 20 times in the time zone t2. The analysis section 103 analyzes the term D being uttered less in a latter half of the meeting than in a former half thereof. In a situation as above, a user can evaluate utterance significant in the meeting decreasing in the latter half of the meeting. As a result, the user can evaluate the meeting elaborately through effective utilization of the utterances and the meeting report.

A description will be made next about another configuration in which the analysis section 103 analyzes the meeting contents based on the number of utterances of the term D. The analysis section 103 analyzes the meeting contents based on a time zone in the meeting in which the term D is not uttered. For example, the term D is not uttered in a period around which 40 minutes elapses from the start of the meeting, as illustrated in FIG. 3. That is, the analysis section 103 analyzes the term D being not uttered in the period around which 40 minutes elapsed after the start of the meeting. In a situation as above, the user can evaluate for example no topic significant in the meeting being raised in the period around which 40 minutes elapses after the start of the meeting. As a result, the user can evaluate the meeting elaborately through effective utilization of the utterances and the meeting report.

A further description will be made next about another configuration in which the analysis section 103 analyzes the meeting contents based on the number of utterances of the term D. The analysis section 103 analyzes the meeting contents based on the number of utterances during the meeting from among utterances by respective participants of the meeting. For example, in a situation in which a plurality of participants participated in the meeting and a specific participant did not utter in the meeting, the analysis section 103 analyzes the specific participant not having uttered in the meeting. In the above configuration, the user can evaluate for example whether or not the specific participant may have had to participate in the meeting. As a result, the user can evaluate the meeting further elaborately through effective utilization of the utterances and the meeting report.

A still further description will be made next about still another configuration in which the analysis section 103 analyzes the meeting contents based on the number of utterances of the term D. In a situation in which there is a plurality of terms D, the user can optionally set a degree of significance for each of the terms D. The analysis section 103 analyzes the meeting contents through comparison between the numbers of utterances of the plurality of terms D and the number of utterances of the term D for which a high degree of significance is set among the plurality of terms D. For example, in a situation in which a plurality of participants participated in the meeting and a specific participant uttered a little while uttering the term D for which the high degree of significance is set, the analysis section 103 analyzes the specific participant having a high ratio of the number of utterances of the term D for which the high degree of significance is set relative to the number of utterances by the specific participant. In a situation as above, the user can evaluate for example the specific participant being a participant important in the meeting. As a result, the user can evaluate the meeting further elaborately through effective utilization of the utterances and the meeting report.

A description will be made next about a configuration in which the analysis section 103 analyzes the meeting contents through comparison between a duration length of the meeting and a total time length of the utterances of the term D. For example, the term D is uttered for 19 minutes in total in the first time zone t1, as illustrated in FIG. 3. On the other hand, the term D is uttered for 13 minutes in total in the second time zone t2. That is, the analysis section 103 analyzes the term D having been talked longer in the first time zone t1 than in the second time zone t2. In situation as above, the user can evaluate for example an important topic being talked in the former half of the meeting than in the latter half thereof. As a result, the user can evaluate the meeting further elaborately through effective utilization of the utterances and the meeting report.

A description will be made next abut a configuration in which the analysis section 103 analyzes the meeting contents based on an utterance of an interjection. The retrieval section 102 retrieves an utterance of the interjection from among the utterances during the meeting, that is, the utterances recorded on the voice recorder 40. The interjection is a word uttered when an utterer pauses or is at a loss for words, such as “well”. The analysis section 103 analyzes the number of utterances of the interjection among the utterances during the meeting. In the above configuration, the user can evaluate for example a meeting participant who uttered the interjection many times being unique in phrasing. As a result, the user can evaluate the meeting elaborately through effective utilization of the utterances in the meeting. Furthermore, the user may advise a meeting participant who utters the interjection many times among the meeting participants to speak in a manner to utter the interjection less.

The user can send a questionnaire about the meeting to a terminal of a meeting participant. The terminal of the meeting participant is a personal computer that the meeting participant uses, for example. The meeting participant evaluates the meeting in which he or she participated by replying to the questionnaire using the meeting participant's terminal. The evaluation of the meeting is selection of evaluation data by a meeting participant about a duration length of the meeting in which he or she participated, a time zone in which the meeting was held, and the number of meeting participants. The meeting participant evaluates for example the duration length of the meeting by five levels of “very long”, “long”, “moderate”, “short”, and “very short”.

The receiving section 30 receives data indicating a meeting evaluation from the terminal of the meeting participant. The storage section 20 stores the data indicating the meeting evaluation that the receiving section 30 receives and information that specifies the evaluated meeting in association therewith. The information that specifies the meeting contains the duration length of the held meeting, the time zone in which the meeting was held, and the number of the meeting participants, for example. In the above configuration, the user can evaluate the information that specifies the meeting based on the data indicating the meeting evaluation stored in the storage section 20. For example, in a situation in which many meeting participants evaluate the duration length of the meeting being very long, the user evaluates the duration length of the meeting being very long. As a result, the user can evaluate the meeting elaborately through effective utilization of the information processing device 1. For example, the user can improve a next meeting by shortening a duration length of the next meeting.

The image scanning section 110 scans an image of either a meeting memorandum or a note on a whiteboard used in the meeting through optical character recognition. The meeting memorandum is for example a memorandum about the meeting hand written by a meeting participant in the meeting. The extraction section 101 extracts the term D contained in the image. The retrieval section 102 retrieves an utterance of the term D contained in the image from among the utterances during the meeting recorded on the voice recorder 40. The analysis section 103 analyzes the meeting contents based on the utterance of the term D contained in the image.

In the above configuration, the meeting contents are analyzed based on the term D contained in not only the meeting report but also a note on the whiteboard used in the meeting or in the meeting memorandum. In the above configuration, the user can evaluate the meeting based on a result of further detailed analysis. As a result, the user can elaborately evaluate the meeting through effective utilization of the utterances, the meeting report, the meeting memorandum, and the note on the whiteboard used in the meeting.

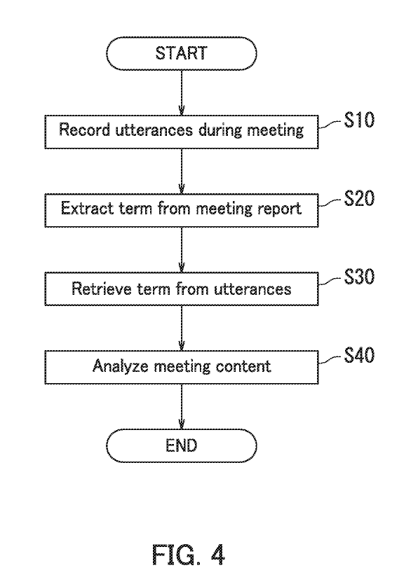

Following describes control for analysis of meeting contents executed by the information processing device 1 with reference to FIGS. 1-4. FIG. 4 is a flowchart depicting a control flow for analysis of the meeting contents. Through execution of Steps S10 through to S60, the analysis section 103 can analyze the meeting contents. A specific flow is as follows.

At Step S10, the voice recorder 40 records utterances during a meeting on the storage section 20. At Step S20, the extraction section 101 extracts the term D from the meeting report 50. At Step S30, the retrieval section 102 retrieves an utterance of the term D from among the utterances recorded on the storage section 20. At Step S40, the analysis section 103 analyzes meeting contents based on the utterance of the term D.

According to the first embodiment, the meeting contents are analyzed based on not only the meeting report 50 but also the utterances of the term D recorded on the meeting report 50 as described above with reference to FIGS. 1-4. In the above configuration, the user can evaluate the meeting based on an analyzed result. As a result, the user can evaluate the meeting elaborately through effective utilization of the utterances and the meeting report 50.

### Second Embodiment

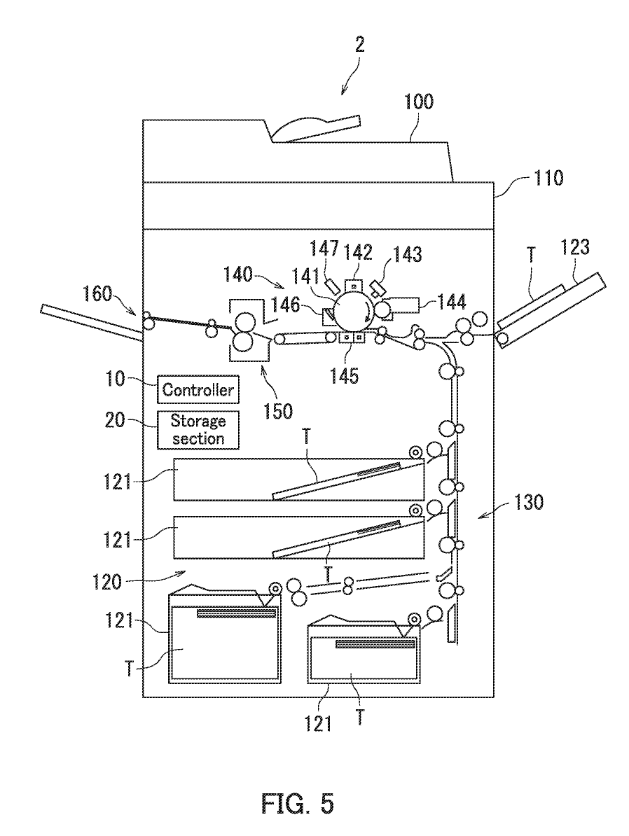

Following describes an image forming apparatus 2 according to a second embodiment of the present disclosure with reference to FIG. 5. FIG. 5 illustrates the image forming apparatus 2. The image forming apparatus 2 is any one of a copier, a printer, a facsimile machine, and a multifunction peripheral, for example. The multifunction peripheral has at least two functions of the copier, the printer, and the facsimile machine, for example.

The image forming apparatus 2 includes a controller 10, a document conveyance section 100, an image scanning section 110, an accommodation section 120, a conveyance section 130, an image forming section 140, a fixing section 150, an ejection section 160, and a storage section 170 that stores a plurality of files therein. A sheet T is conveyed in the image forming apparatus 2 in a sheet conveyance direction.

The controller 10 functions as the controller 10 according to the first embodiment. The storage section 20 functions as the storage section 20 according to the first embodiment. The image scanning section 110 functions as the image scanning section 110 according to the first embodiment. In the above configuration, the controller 10, the storage section 20, and the image scanning section 110 in the image forming apparatus 2 constitute the information processing device 1 according to the first embodiment.

The document conveyance section 100 conveys an original document to the image scanning section 110. The image scanning section 110 scans an image of the original document to generate image data. The accommodation section 120 accommodates sheets T. The accommodation section 120 includes a cassette 121 and a manual feed tray 123. The sheets T are loaded on the cassette 121. The sheets T are fed one at a time from the cassette 121 or the manual feed tray 123 to the conveyance section 130. The sheets T are plain paper, copy paper, recycled paper, thin paper, cardboard, glossy paper, or overhead projector (OHP) sheets, for example.

The conveyance section 130 conveys the sheet T to the image forming section 140, The image forming section 140 includes a photosensitive drum 141, a charger 142, an exposure section 143, a development section 144, a transfer section 145, a cleaner 146, and a static eliminating section 147, and forms (prints) an image on the sheet T. The image forming section 140 forms an image indicating a result of analysis of meeting contents on the sheet T.

The sheet T on which the image has been formed is conveyed to the fixing section 150. The fixing section 150 fixes the image to the sheet T by applying heat and pressure to the sheet T. The sheet T to which the image has been fixed is conveyed to the ejection section 160. The ejection section 160 ejects the sheet T.

The storage section 170 includes a main storage device (for example, a semiconductor memory) and an auxiliary storage device (for example, a hard disk drive).

The controller 10 controls respective elements of the image forming apparatus 2. Specifically, the controller 10 controls the document conveyance section 100, the image scanning section 110, the accommodation section 120, the conveyance section 130, the image forming section 140, and the fixing section 150 through execution of computer programs stored in the storage section 170. The controller 10 is a central processing unit (CPU), for example.

As described with reference to FIG. 5, the image forming apparatus 2 according to the second embodiment functions as the information processing device 1 according to the first embodiment. In the above configuration, a meeting can be evaluated elaborately through utilization of the meeting report 50 in a manner similar to that in the first embodiment.

Embodiments of the present disclosure have been described so far with reference to the drawing (FIGS. 1-5). However, the present disclosure is not limited to the above embodiments and various alterations may he made without departing from the spirit and the scope of the present disclosure (for example, sections (1) and (2) below). The drawings are schematic illustrations that emphasize elements of configuration in order to facilitate understanding thereof. Therefore, properties of each of the elements in the drawings, such as thickness, length, and quantity, may differ from actual properties of the elements for the sake of illustration convenience. Properties of elements of configuration in the above embodiments, such as shape and dimension, are merely examples that do not impose any particular limitations and can be altered in various ways to the extent that there is not substantial deviation from the effects of the present disclosure.

(1) As described with reference to FIG. 3, the analysis section 103 analyzes the meeting contents based on either or both of the number of utterances of the term D and the total time length of the utterances of the term D. However, in a situation in which there are a plurality of terms D, the meeting contents may be analyzed based on either or both of the numbers of utterances of the respective terms D and the total time lengths of the utterances of the respective terms D. Alternatively, the meeting contents may be analyzed based on either or both of the total number of utterances of the respective terms D and the total time length of the utterances of the respective terms D.

(2) As described with reference to FIGS. 1-5, the user can evaluate the meeting elaborately through utilization of the utterances and the meeting report. The user may distribute sheets T on which an image indicating an elaborate evaluation result is formed using the image forming section 140 or transmit data indicating the elaborate evaluation result to terminals of meeting participants via a network.

What is claimed is:

1. An information processing device that utilizes a meeting report on a meeting, comprising:
a voice recorder configured to record utterances during the meeting;
a retrieval section configured to retrieve an utterance of a term entered in the meeting report from among the utterances recorded on the voice recorder; and
an analysis section configured to analyze a content of the meeting based on the utterance of the term.

2. The information processing device according to claim 1, wherein
the analysis section analyzes the content of the meeting based on either or both of a number of utterances of the term and a total time length of the utterance of the term.

3. The information processing device according to claim 1, wherein
the analysis section analyzes the content of the meeting through comparison between a number of utterances of the term in a first time zone of the meeting and a number of utterances of the term in a second time zone of the meeting.

4. The information processing device according to claim 1, wherein
the analysis section analyzes the content of the meeting through comparison between a duration length of the meeting and the total time length of the utterance of the term.

5. The information processing device according to claim 1, further comprising:
an image scanning section configured to scan an image of either a note on a whiteboard used in the meeting or a meeting memorandum, wherein
the retrieval section retrieves the utterance of the term contained in the image from among the utterances recorded on the voice recorder, and
the analysis section analyzes the content of the meeting based on the utterance of the term contained in the image.

6. The information processing device according to claim 1, wherein
the retrieval section retrieves an utterance of an interjection from among the utterances during the meeting, and
the analysis section analyzes the content of the meeting based on the utterance of the interjection.

7. The information processing device according to claim 1, further comprising:
a receiving section configured to receive data indicating a meeting evaluation from a terminal of a participant in the meeting, and
a storage section configured to store the data indicating the meeting evaluation and information that specifies the meeting in association therewith.

8. The information processing device according to claim 1, wherein
the term includes a plurality of terms for each of which a degree of significance is set, and
the analysis section analyzes the content of the meeting through comparison between numbers of utterances of the plurality of terms and a number of utterances of a term for which a high degree of significance is set among the terms.

9. The information processing device according to claim 1, wherein
the analysis section analyzes the content of the meeting based on a time zone of the meeting in which the term is not uttered.

10. An image forming apparatus comprising:
the information processing device according to claim 1; and
an image forming section configured to form an image indicating a result of analysis of the meeting on a sheet.
